(19) United States
(12) Patent Application Publication
(10) Pub. No.: US 2015/0180095 A1
(43) Pub. Date: Jun. 25, 2015

(54) Systems and Methods for Conducting Battery Heat Using Pouch Cells

(71) Applicant: GM GLOBAL TECHNOLOGY OPERATIONS LLC, Detroit, MI (US)

(72) Inventors: Kuo-Huey Chen, Troy, MI (US); Taeyoung Han, Bloomfield Hills, MI (US); Chih-Hung Yen, West Bloomfield, MI (US)

(73) Assignee: GM GLOBAL TECHNOLOGY OPERATIONS LLC, Detroit, MI (US)

(21) Appl. No.: 14/133,970

(22) Filed: Dec. 19, 2013

(51) Int. Cl. H01M 10/613; H01M 10/625; H01M 10/6551; H01M 10/42; H01M 2/02; H01M 10/647

(52) U.S. Cl. CPC H01M 10/5004; H01M 2/0285; H01M 10/5032; H01M 10/5046; H01M 10/4207; H01M 10/5016; H01M 2220/20

(57) ABSTRACT

The present disclosure relates to apparatuses for conducting battery heat comprising an active material positioned between a first cover portion and second cover portion, each portion comprising a thermal conductive material and protection material connected to the thermal conductive material. Also included are systems for conducting heat includes a plurality of pouch cells each comprising an active material positioned between a first cover portion and second cover portion and a plurality of frames, at least one frame positioned between each of the plurality of pouch cells. Finally included are methods, for assembling a pouch cell structure for use in conducting battery heat, comprising constructing a pouch cell assembly by alternating a sequence of pouch cells and frames; positioning a first contact edge of each of pouch cell proximal to a first heat sink and a second contact edge of each pouch cells proximal to a second heat sink opposite the first contact edge; and connecting the first heat sink to the first contact edge of each of the plurality of pouch cells and connecting the second heat sink to the second contact edge of each of the plurality of pouch cells.

### TECHNICAL FIELD

The present technology relates to thermal conduction associated with vehicle batteries. More specifically, the present technology relates to accomplishing desired thermal conduction using concurrent pouch cell materials and extended pouch cell edges.

### BACKGROUND

Thermal energy (i.e., heat) can be dissipated or conducted using a pouch cell. A pouch cell is an electrode assembly containing electrode lead tabs that carry the positive and negative terminals to the outside of a sealed, flexible case or pouch. Pouch cells are lightweight and flexible in nature, due to an absence of metal casing, and are preferred to cylindrical cells for certain applications.

Heat transfer using pouch cells have a wide array of application including grid energy storage, computer hardware, and vehicle batteries.

Attempts have been made to reduce the weight of pouch cells without altering dissipation or conduction properties. One attempt has been to reduce the thickness of the pouch cell by reducing the number of layers within the electrode assembly. Although reducing the number of layers within the electrode assembly reduces the thickness of the pouch cell, the solution also reduces heat transfer through the pouch cell because heat transfer through an electrode assembly is directly related to the number of electrode layers.

Additionally, this solution does not consider altering the cover material of the pouch cell to include a conductive layer that conduct heat, which will exist as a result of reducing the number of layers within the electrode assembly.

According to another technique, more heat may be propagated by the pouch cell combined with a heat sink. When joining the pouch cell with the heat sink, sufficiency of thermal contact between the two is critical. Ways to ensure robust thermal contact between the pouch cell and the heat sink have included using thermal paste or conductive tape. Shortcomings of using this technique include unwanted additional mass of the paste or tape and possible weakening of the thermal contact by wearing away of the paste/tape over an extended time.

### SUMMARY

Given the aforementioned deficiencies, a need exists for systems and methods that efficiently enhance conduction of thermal energy using a pouch cell.

The present disclosure relates to systems and methods for implementing a thermal conduction apparatus. The systems and methods satisfy the aforementioned need using conductive materials and protective materials within a pouch cell cover. The systems and methods also form robust thermal contact between the pouch cell and at least one heat sink.

In operation, conduction of heat occurs through the edges of the pouch cell and the pouch cell cover including concurrent layered materials. Additionally, heat transfer occurs through the robust contact connecting the pouch cell to the at least one heat sink.

Included in the present technology are apparatuses for conducting heat includes a pouch cell containing an active material positioned between a first cover portion and second cover portion, each portion comprising a thermal conductive material and protection material connected to the thermal conductive material. Additionally, the first cover portion is connected to the second cover portion at a first contact edge and at a second contact edge opposite the first contact edge.

Also included is in the present technology are systems for conducting heat includes a plurality of pouch cells each comprising an active material positioned between a first cover portion and second cover portion and a plurality of frames, at least one frame positioned between each of the plurality of pouch cells.

In some embodiments, the protection material may be located on each side of the thermal conductive material.

In some embodiments, the first and second cover portions also contain barrier material adjacent to the protection material of both the first and second cover portions. Within some specific embodiments, the barrier material is located adjacent an outer surface exposed to atmosphere.

In other embodiments, the first and second contact edges each contain a curvilinear section located at a juncture created by the first and second cover and the active material. In some embodiments, the curvilinear sections of the first and second contact edges connect respectively to a first and second heat sink.

Finally, included in the present technology are methods, for assembling a pouch cell structure for use in conducting battery heat, comprising constructing a pouch cell assembly by alternating a sequence of pouch cells and frames; positioning a first contact edge of each of pouch cell proximal to a first heat sink and a second contact edge of each pouch cells proximal to a second heat sink opposite the first contact edge; and connecting the first heat sink to the first contact edge of each of the plurality of pouch cells and connecting the second heat sink to the second contact edge of each of the plurality of pouch cells.

In these methods, at least one frame is located adjacent a first cover portion of a pouch cell and another frame is located adjacent a second cover portion of the same pouch cell.

In some embodiments, the connecting further comprises compressing the pouch cell assembly through uniform contact perpendicular to the top of the pouch cell assembly.

In other embodiments, the connecting further comprises bending the first contact edge and second contact edge of each pouch cell to a position perpendicular to the top of the pouch cell assembly.

In other embodiments, the connecting further comprises adhering the first and second contact edges of each pouch cell respectively to a first buffer and a second buffer.

In yet other embodiments, the connecting further comprises encircling a restraint around a perimeter formed by the pouch assembly and the first and second heat sinks located on either side of the pouch assembly.

In yet other embodiments, the connecting further comprises contouring a contact surface on the first and second heat sinks, such that the distance to connect the respective first and second contact edges of each pouch cells and the respective first and second sinks is decreased.

Other aspects of the present technology will be in part apparent and in part pointed out hereinafter.

### DESCRIPTION OF THE DRAWINGS

FIG. 1 is a perspective view of a pouch cell with extended edge in accordance with an exemplary embodiment.

FIG. 2 is a front view of another pouch cell having extended edges containing curvilinear sections.

FIG. 3 is a cross-sectional view of another type of pouch cell.

FIG. 4 is a side view of a plurality of pouch cells positioned to create contact with a heat sink.

FIG. 5 is a perspective view of the plurality of pouch cells of FIG. 4 after creating contact with a heat sink.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, illustrative, and similar terms, refer expansively to embodiments that serve as an illustration, specimen, model or pattern.

Descriptions are to be considered broadly, within the spirit of the description. For example, references to connections between any two parts herein are intended to encompass the two parts being connected directly or indirectly to each other. As another example, a single component described herein, such as in connection with one or more functions, is to be interpreted to cover embodiments in which more than one component is used instead to perform the function(s). And vice versa—i.e., descriptions of multiple components herein in connection with one or more functions are to be interpreted to cover embodiments in which a single component performs the function(s).

In some instances, well-known components, systems, materials or methods have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

While the present technology is described primarily in connection with a vehicle in the form of an automobile, it is contemplated that the technology can be implemented in connection with other vehicles, such as marine craft and air craft.

While the technology is described primarily in connection with vehicle batteries, the technology is not limited to use with vehicle batteries. Other applications include cooling batteries used in grid energy storage and non-vehicle computers, as just two examples.

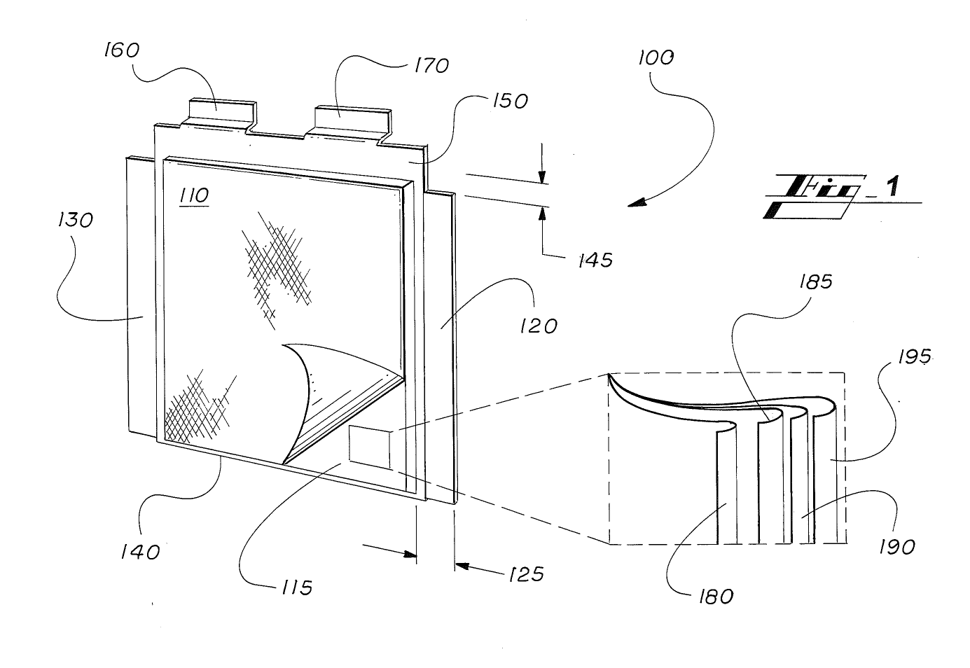

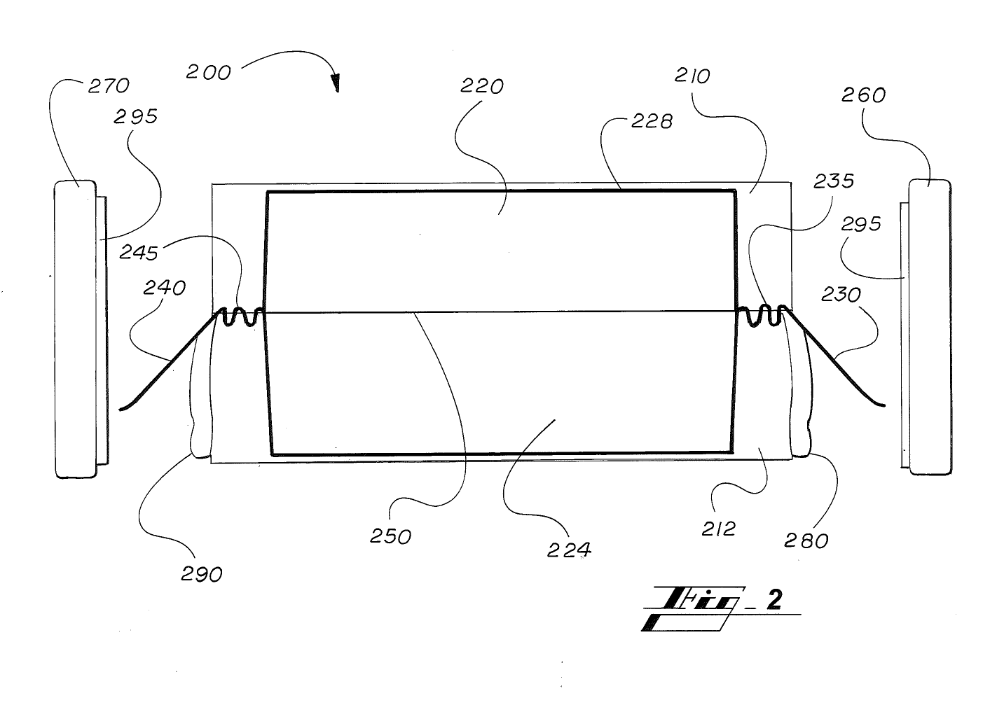

### I. OVERVIEW OF THE POUCH CELL—FIGS. 1 AND 2

FIG. 1 is a perspective view of a pouch cell 100. The pouch cell 100 includes a pouch cell cover 110 and an active pouch cell material 115 (seen in callout of FIG. 1). The pouch cell 100 also includes pouch cell contact edges 120, 130 and closure edges 140, 150.

The active material 115 of the pouch cell 100 is located behind the material of the cover 110. The active material 115 is a conductive material configured and arranged to conduct heat from the battery—e.g., vehicle battery, via a set of electrode leads in connection with an active material. More specifically, the active material 115 is a cell assembly in which a positive electrode 180, at least one separator 185 (e.g., an electrolyte), and a negative electrode 190 are stacked or wound to form the cell assembly. A positive electrode lead 160 and a negative electrode lead 170 are attached to the positive electrode 180 and the negative electrode 190, respectively, and extend from the pouch closure edge 150 for connection with the vehicle battery.

The active material 115 is coated with a current collector 195, e.g., a thin Al or Cu plate made of aluminum, copper, or other conducing material, and attached to the electrode leads 160, 170. Note that additional configurations of electrode cell assemblies known within the art may be practiced in accordance with the present technology.

The active material 115 of the pouch cell may contain any material that conducts heat including but not limited to lithium cobalt oxide, lithium manganese dioxide, and/or lithium iron phosphate.

The active material 115 of the pouch cell is commonly contained by an outer layer. More specifically, the active material 115 is in one embodiment contained by the cover 110 of the pouch cell 100.

The cover 110 of the pouch cell 100 in one embodiment includes a sheet (or multiple sheets) of material sealed on its side/sides—e.g., sealed at each of the four sides of the active material 115 of the pouch cell shown in FIG. 1. The function of the cover 110 is to protect and contain the active material 115 of the pouch cell 100. Additionally, the cover 110 of the pouch cell 100 is intended to conduct heat from the vehicle battery. As such, the cover 110 in some embodiments comprises materials having both protecting properties as well as heat-conducting properties.

As to not unnecessarily increase mass of the pouch cell 100, the cover 110 is in one embodiment designed as a thin layer. For example, a layer of pouch cell cover 110 may be between approximately 1% and approximately 5% of an overall thickness of the pouch cell 100.

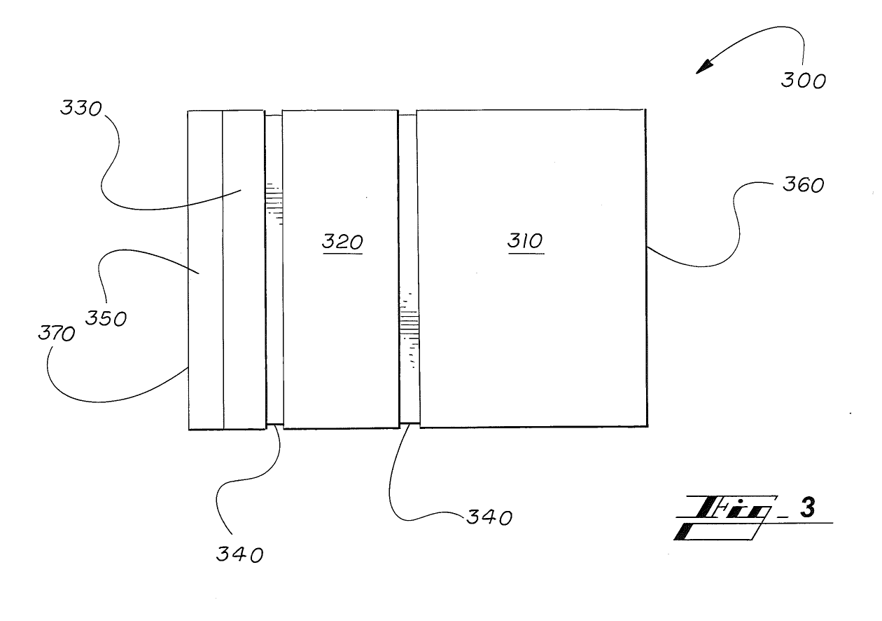

Further details concerning the structure and composition of the cover of the pouch cell are described below in association with FIGS. 2 and 3.

In one embodiment, the contact edges 120, 130 and the closure edges 140, 150 are created by first placing the active material 115 between sheets of the pouch cell cover 110. When the sheets of the cover 110 surround the active material 115, the portions of the cover 110 not in contact with the active material 115 are cohesively connected (e.g., adhered) to create a seal around the active material 115. The seal created by the layers of cover 110 in turn creates the four edges, i.e., contact edges 120, 130 and the closure edges 140, 150. Closure edge 150 attaches a positive electrode lead 160 and a negative electrode lead, 170 to the active material 115 and secures in position the electrode leads 160, 170.

The closure edges 140, 150 seal the pouch cell 100 at the edges, containing the active material 115. The contact edges 120, 130 similarly contain the active material 115 through sealing the pouch cell 100.

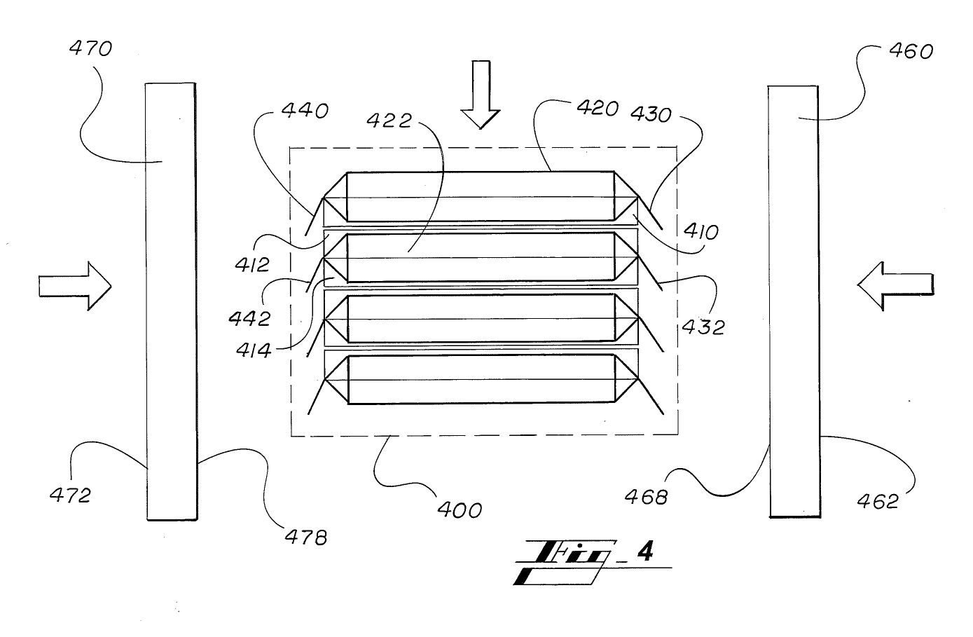

The contact edges 120, 130 function additionally to connect the pouch cell 100 with one or more heat sinks (shown FIG. 2 and FIG. 4). In the contemplated embodiment, the heat sinks are connected to pouch cell 100, alternatively, in addition to, or by way of the contact edges 120, 130.

Adequate connection between the contact edges 120, 130 and the heat sinks is vital for conducting heat as desired from the vehicle battery to a cooling system contained within the heat sinks, which dissipate the heat transferred by the contact edges 120,130.

To promote the role of the contact edges 120, 130 to connect the pouch cell 100 to the heat sinks, the contact edges 120, 130 in one embodiment each has a greater width than widths of the closure edges 140, 150, especially in embodiments in which the closure edges do not perform such an adhering function. More specifically, a contact edge width 125 is greater in width than the closure edge width 145.

Further details concerning structure of the pouch cell contact edges are described in association with FIG. 2.

FIG. 2 is a side view of a pouch cell structure 200. The pouch cell structure 200 is in turn part of a pouch cell assembly, shown in FIG. 4. The pouch cell structure 200 includes a pouch cell 220 and pouch cell edges. In some embodiments the pouch cell 220, specifically an active material 224 and a pouch cell cover 228, are similar in function and character to the pouch cell 100 and its components described in association with FIG. 1. In other embodiments, the pouch cell 220 includes additional features to enhance thermal contact between the pouch cell 220 and heat sinks 260, 270.

Similar to the pouch cell cover 110 described in FIG. 1, a pouch cell cover 228 in some embodiments includes sheets of material configured and arranged to encase and protect an active material 224 as well as to conduct heat from the vehicle battery. For these purposes, the cover 228 of the pouch cell 220 may include materials having protecting properties as well as heat-conducting properties. Further details concerning composition of the cover are described in association with FIG. 3.

As described in FIG. 1, sheets of the cover 228 seal to create four edges along the perimeter of the pouch cell structure 200, specifically two contact edges and two closure edges. The pouch cell structure 200, illustrates contact edges 230, 240 as well as a closure edge 235. The second closure edge (not illustrated) is located on the opposite side of the closure edge 235. The closure edge 235 and the second closure edge exist to ensure the active material 224 is contained within the sheets of the cover 228. In addition to containing the active material 224, the contact edges 230, 240 connect the pouch cell structure 200 to a heat sink 260 and a heat sink 270 where heat is removed from the pouch cell structure 200.

The contact edges 230, 240 may include additional conductive material such as foil or sealing film to enhance the sheets of material within the cover 228. These additional conductive materials may also be used to extend the contact edge 230, 240 to a width greater than the original width.

The initial orientation of the contact edges 230, 240, prior to the attachment of the heat sinks 260, 270, is on a linear plane parallel to the linear plane of the closure edge 235. However, when heat sinks 260, 270 are attached, the final orientation of the contact edges 230, 240 is on a plane that is perpendicular to the closure edge 235. This perpendicular orientation will allow substantial contact with the heat sinks 260, 270. Therefore, the width of the contact edges 230, 240, such as the width 125 described in FIG. 1, should be such that the contact edges 230, 240 may fold to create a perpendicular orientation. For example, the contact edges 230, 240 may have a width approximately between 1 and 100 millimeters, depending on the pouch cell structure 200.

Properly connection of the contact edges 230, 240 to the heat sinks 260, 270, is a critical purpose of the pouch cell structure 200. Options to improve connection, and thus improve thermal contact, include among others: using frames to secure the position of the pouch cell 220, curvilinear sections within the contact edges 230, 240; using buffers 280, 290 within the pouch cell structure 200; using a thermal adhesive 295 on the heat sinks 260, 270.

In some embodiments, the pouch cell 220 is secured by frames 210, 212. The frame 210 may be positioned adjacent to a surface created by a sheet of the cover 228 on one side of the pouch cell 220, and the frame 212 may be positioned adjacent to a surface created by a sheet of the cover 228 on the opposite side of the pouch cell 220. Both frames 210, 212 serve to securely position the pouch cell 220. In these embodiments, the frame 212 also serve as the point of contact between the contact edge 230 and heat sinks 260 as well as the point of contact between the contact edge 240 and the heat sink 270.

In certain embodiments, the frames 210, 212 may include a cutout within the frame molding that facilitates the automatic bending of the contact edges 230, 240. Automatic bending creates an orientation of the contact edges 230, 240 that is in close proximity to a plane perpendicular to the linear plane of the closure edge 235. When the contact edges 230, 240 have an orientation that near the desired perpendicular plane, connection to the heat sinks 260, 270 becomes easier.

Further qualities and characteristics of support frames such as frames 210, 212 are well known in the art and will not be described in further detail.

In some embodiments, the contact edges 230, 240 include curvilinear sections 235 and 245, respectively. The curvilinear sections 235 and 245 create ridges within the contact edges 230, 240. Ridges provide the contact edges 230, 240 the ability to stretch and bend during expansion and contraction of the pouch cell structure 200. The ability of the curvilinear sections 235 and 245 to stretch and bend reduces the amount of stress experienced by the remaining portion the contact edges 230, 240, which may prevent reduced thermal contact over time between the contact edges 230, 240 and the heat sinks 260, 270.

In some embodiments, the pouch cell structure 200 may include buffers 280, 290 between the frame and the contact edge. The buffers 280, 290 create uniform contact between the contact edges 230, 240 and the heat sinks 260, 270. The buffers 280, 290 improve thermal contact by increasing contact pressure between the pouch cell structure 200 and the heat sinks 260, 270. Since the thermal conductivity between the contact edge 230, 240 and the heat sinks 260, 270 depends on the contact pressure, higher and uniform contact pressure will increase the heat flow by increased heat conduction.

The buffer 280 is located between the frame 212 and the contact edge 230, and improves contact between the heat sink 260 and the contact edge 230. Similarly, the buffer 290 is located between frame 212 and the contact edge 240 and creates improved contact between the heat sink 270 and the contact edge 240. The buffers 280, 290 allow a uniform contact to be created between the contact edges 230, 240 and their respective heat sinks 260, 270. The buffers 280, 290 also ensure adherence between contact edges 230, 240, and their respective heat sinks 260, 270 to improve the heat transfer from the pouch cell structure 200 to the heat sinks 260, 270. Contact buffers, such as the buffers 280, 290, may be made of any insulating material such as rubber, silicone, or other polymers known in the art.

In addition to curvilinear sections and buffers, the heat sinks 260, 270 may include a thermal adhesive 295 to improve contact with the pouch cell structure 200. The thermal adhesive 295 would be applied to the surface of the heat sinks 260, 270 that are connected to the contact edges 230, 240, e.g., contact surfaces 268 and 278 respectively. Thermal adhesives such as thermal paste/epoxy or conductive tape are used throughout the art to improve contact and heat transfer between items.

Other embodiments can include a mechanical means of attaching the contact edges 230, 240 to the heat sinks 260, 270. The mechanical means can be used for independent attachment or in conjunction with the thermal adhesive 295. Mechanical means can include but are not limited to clips, such as wire-form or flat spring, spacers, or push pins.

### II. POUCH CELL COMPOSITION—FIG. 3

FIG. 3 is a cross sectional view of the cover material included in a cover assembly 300. The cover assembly 300 includes successive layers of conductive material to conduct heat as well as protection material to shield the conductive material. The cover assembly 300 has an inner surface 360, which is adjacent to an active material 115 (shown in the call out of FIG. 1), and an outer surface 370, which is adjacent to the atmosphere, e.g., air between one pouch cell and the next pouch cell within a multi pouch cell assembly, as described in FIG. 4.

The cover assembly 300 includes a conductive layer 320, which provides additional conduction as heat flows from the active material to the atmosphere. A first conduction occurs within the active material. As heat flows through the inner surface 360, to the cover material assembly 300, a second conduction of heat occurs due to the conductive layer 320. Finally, heat is dissipated when it is delivered to a heat sink (not shown in FIG. 3).

For maximum heat distribution a single conductive layer is suggested, however, multiple conductive layers may be used to achieve the same rate of heat distribution.

The conductive layer 320 may have a thermal conductivity (K) approximately between 200 W/m/K and 500 W/m/K. For example, the conductive material may include materials such as but not limited to aluminum (K≈200 W/m/K), copper (K≈300 W/m/K), graphite (K≈400 W/m/K). Additional material properties such as heat capacity, thermal conductivity, and thermal expansion may be used in selecting a conductive material.

The thickness of the conductive layer 320 is typically inversely proportional to the thermal properties of the conductive material. More specifically, as the thermal conductivity coefficient increases, the required thickness of the conductive layer 320 decreases. Therefore, the thickness of the conductive layer 320 may vary depending on the conductive material used.

The thickness of the conductive layer 320 should be such that efficient heat conduction occurs. This heat conduction can be measured through the change in temperature (ΔT) or other quantitative factor. For example, when striving for a ΔT of 5° C., if aluminum is the conductive material, the thickness of the conductive material may be between 30 microns and 50 microns. However, if copper is the conductive material in the same scenario, the thickness of the conductive material may only need to be between 20 and 40 microns. As the desired ΔT changes for different applications, so does the thickness of the conductive layer 320.

In addition to the conductive layer 320, the cover material assembly 300 includes protection layers 310 and 330. The protection layers 310 and 330 are connected to either side of the conductive layer 320 through a bonding layer 340. The bonding layer 340 can be any means of bonding that is known in the art such as but not limited to thermoset polymers, thermoplastic material, solvent-cast adhesive, or glue. In certain embodiments, the bonding layer 340 of the protection layers 310 and 330 to the conductive layer 320 may occur through heat fusion.

The protection layers 310 and 330 may be made of the same material or differing materials. Materials for the protection layers 310 and 320 may include, but are not limited to, polypropylene (PP), polyvinyl chloride (PVC), high density polyethylene (HDPE), polyamide (PA) nylon, or other similar materials.

The thickness of the protection layers 310, 330 may be dependent on the material used. However, the protection layer 310 may likely have a greater thickness than the protection layer 330 due to the fact that the protection layer 310 is directly adjacent to the inner surface 360, which receives heat transfer from the active material of the pouch cell.

As an example, if the conductive layer 320 has a thickness of 50 microns, the protection layer 310 would be approximately between 100 and 150 microns. Additionally, the protection layer 330 would be approximately between 25 and 75 microns.

In certain embodiments, the cover material assembly 300 may include a barrier layer 350. The barrier layer 350 would serve as additional protection by preventing penetration of the pouch cell structure. The barrier layer 350 would separate the protection layer 330 from the outer surface 370. Since the barrier layer 350 serves as a blockade, the thickness of the barrier layer 350 would be likely be less than the conductive layer 320. The barrier layer 350 may be made from materials including but not limited polyethylene terephthalate (PET) and Polybutylene terephthalate (PBT).

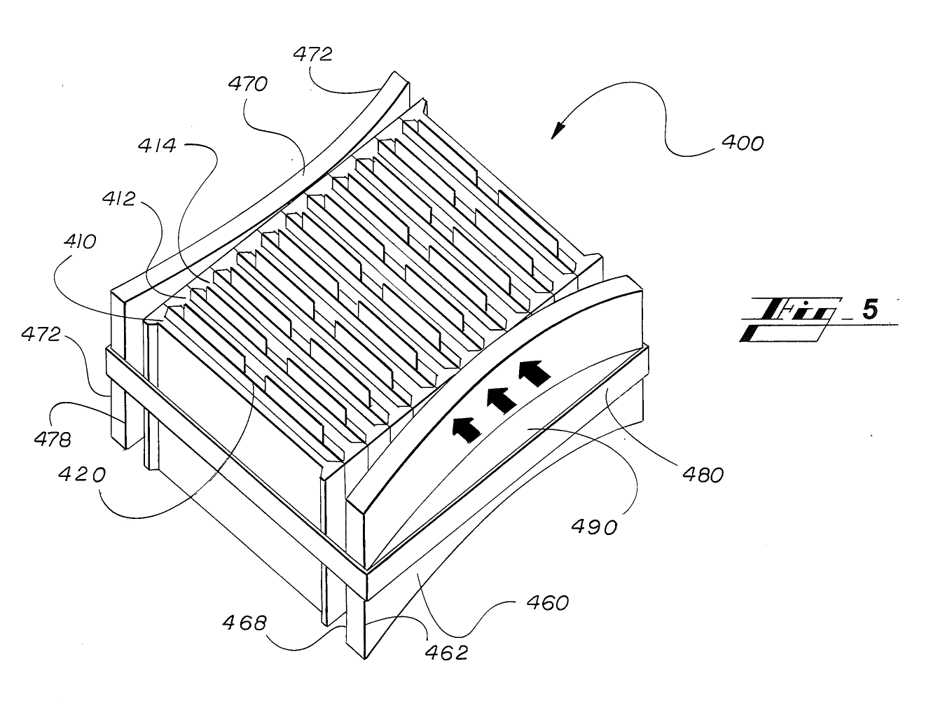

### III. POUCH CELL ASSEMBLY—FIGS. 4 AND 5

FIG. 4 is a side view of a pouch cell assembly 400 containing multiple pouch cell structures. The pouch cell assembly 400 includes a plurality of frames and a plurality of pouch cell structures. Included in the plurality of pouch cell structures is a pouch cell structure 420, which includes contact edges 430, 440. The contact edges 430, 440 connect to heat sinks 460, 470, respectively. Similarly, a pouch cell structure 422 includes contact edges 432 and 442, which connect to heat sinks 460, 470 respectively. The same pouch cell structure exists for all pouch cells within the pouch cell assembly 400.

Options to improve connection and thermal contact are similar to the options discussed in association with FIG. 2. These options include the use of frames; the use of curvilinear sections (not shown, see reference numerals 235, 245 in FIG. 2) within the contact edges; the use of buffers (not shown, see reference numerals 280, 290 in FIG. 2); the use of thermal adhesive on the heat sinks (not shown, see reference numeral 295 in FIG. 2). Each pouch cell may be secured by frames located on either side of the surfaces created by the pouch cells 420, 422, etc. The frames serve to position the pouch cells and serve as a point of contact between the contact edges 430, 432, etc. and heat sink 460 and the contact edges and 440, 442, etc. and the heat sink 470.

The contact edges 430, 432, etc. and 440, 442, etc. may include curvilinear sections to allow for the expansion and contraction of pouch cell structure 200.

The buffers may be used to create uniform contact between the contact edges, e.g., 430, 440, and the heat sinks 460, 470 and would be located between a frame and a contact edge. Note that buffers may be used on all frames regardless of proximity to the contact edges. For example, a buffer would be located between frame 410 and the contact edge 430, and another buffer would be located between the frame 410 and the contact edge 440. For example, buffers may be located between frame 414 and the contact edges 432, 442. Additionally, buffers may also be located on frame 412 to create additional contact surface area for the contact edges 430, 440.

The thermal adhesive may be the similar to the thermal adhesive 295 discussed in association with FIG. 2. The thermal adhesive would be applied to the surface of the heat sinks 460, 470 that are connected to the contact surfaces 468, 478. Thermal adhesives such as thermal paste/epoxy or conductive tape are used throughout the art to improve contact and heat transfer between items.

In some embodiments may include a mechanical means (not shown) of attaching the heat sinks 460, 470 to the pouch cell assembly 400. The mechanical means can be used for independent attachment or in conjunction with an adhesive, e.g., the thermal adhesive 295. Mechanical means can include but are not limited to clips, such as wire-form or flat spring, spacers, or push pins.

FIG. 5 is a perspective view of the pouch cell assembly 400 after it has been connected to the heat sinks 460 and 470.

Options to improve connection and thermal contact are similar to the options discussed in association with FIGS. 2 and 4. Additionally, as seen in FIG. 5, thermal connection may be improved through encircling a restraint 480 around the perimeter of the pouch cell assembly 400, or creating contoured heat sinks.

The restraint 480 may be used to increase connection between each of the pouch edges within the pouch cell assembly 400 and the heat sinks 460, 470. The restraint 480 would wrap around the perimeter of the heat sinks 460, 470 with the pouch cell assembly 400 inserted therebetween, creating points of contact with the exterior surface 462 on the heat sink 460 and the exterior surface 472 on the heat sink 470. The restraint 480 may be any non-conducting material used to secure the overall pouch cell assembly 400 including but not limited to belts, straps, or cords.

The contoured heat sink would include a convex surface to improve thermal contact during attachment of the heat sinks 460, 470 to the contact edges 430, 440. The convex section would be along the contact surfaces 468 and 478.

In other embodiments, the exterior surfaces 462, 472 may also be contoured in embodiments that include a restraint 480. Contoured heat sink embodiments may also include an insert 490 to create contact between the restraint 480 and the heat sink exterior surfaces 462 and 472. The contoured heat sink would secure the contact surfaces 468, 478 to each of the contact edges included within the pouch cell assembly 400.

### IV. CONCLUSION

Various embodiments of the present disclosure are disclosed herein. The disclosed embodiments are merely examples that may be embodied in various and alternative forms, and combinations thereof.

The law does not require and it is economically prohibitive to illustrate and teach every possible embodiment of the present technology. Hence, the above-described embodiments are merely exemplary illustrations of implementations set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

What is claimed is:

1. An apparatus, for conducting battery heat, comprising:
an active-material comprising a positive electrode layer, a negative electrode layer, and a separator layer positioned between the positive electrode layer and the negative electrode layer; and
a cover comprising a first portion and a second portion;
the first cover portion comprising:
a first thermal conductive material, arranged in a layer parallel to the positive electrode layer and the negative electrode layer within the active material, and
a first protection material connected to the first thermal conductive material; and
the second cover portion comprising:
a second thermal conductive material, arranged in a layer that is parallel to the positive electrode layer and the negative electrode layer within the active material; and
a second protection material connected to the second thermal conductive material,
wherein the active material is positioned between the first cover portion and the second cover portion, and the first cover portion is connected to the second cover portion at a first contact edge and at a second contact edge opposite the first contact edge.

2. The apparatus of claim 1, wherein the first cover portion further comprise a barrier material in a layer adjacent to the first protection material and the second cover portion further comprise a barrier material in a layer adjacent to the second protection material.

3. The apparatus of claim 2, wherein the barrier material is located adjacent an outer surface exposed to atmosphere.

4. The apparatus of claim 1, wherein the first protection material further comprise a plurality of layers positioned on both sides of the first thermal conductive material and the second protection material further comprise a plurality of layers positioned on both sides of the second thermal conductive material.

5. The apparatus of claim 4, wherein the first cover portion and second cover portion further comprise a first barrier material and a second barrier material, respectively in first and second layer located adjacent an outer surface exposed to atmosphere.

6. The apparatus of claim 4, wherein the first cover portion and the second cover portion further comprise respectively a first and second barrier material in a layer located adjacent to an inner surface of the first and second protection material, the inner surface being adjacent to the active material.

7. The apparatus of claim 1, wherein the first contact edge is connected to a first heat sink and contains a first curvilinear section located at a first juncture on the first end of a first connected area near the active material, and the second contact edge, is connected to a second heat sink and contains a second curvilinear section located at a second juncture on the second end of a second connected area near the active material.

8. A system, for conducting battery heat, comprising:
a plurality of pouch cells, each pouch cell comprising:
a first cover portion;
a second cover portion; and
an active material located between the first cover portion and the second cover portion;
wherein:
the active material is positioned between the first cover portion and the second cover portion;
the first cover portion is connected to the second cover portion to create a first contact edge at a first end of a connected area created by the first cover portion and the second cover portion; and
a plurality of frames, at least one frame positioned between each of the plurality of pouch cells, wherein a first frame is located adjacent to the first cover portion and a second frame is located adjacent to the second cover portion.

9. The apparatus of claim 8, wherein the first cover portion further comprises a first barrier material in a layer adjacent to a first outer surface exposed to atmosphere and the second cover portion further comprises a second barrier material in a layer adjacent to a second outer surface exposed to atmosphere.

10. The apparatus of claim 8, wherein the first cover portion and second cover portion further comprise respectively a first barrier material in a layer adjacent to a first inner surface and a second barrier material in a layer adjacent to a second inner surface, the first and second inner surfaces being adjacent to the active material.

11. The apparatus of claim 8, wherein the first contact edge, connected to a first heat sink, contains a first curvilinear section located at a first juncture approximately near the active material.

12. The apparatus of claim 8, further comprising a second contact edge, located at a second end of the connected area, and opposite the first end.

13. The apparatus of claim 12, wherein the second contact edge, connected to a second heat sink, contains a curvilinear section located at a second juncture approximately near the active material.

14. The apparatus of claim 12, wherein the first contact edge, connects to a first heat sink, contains a curvilinear section located at a juncture approximately near the active material and the second contact edge, connected to a second heat sink, contains a curvilinear section located at a juncture approximately near the active material.

15. A method, for assembling a pouch cell structure for use in conducting battery heat, comprising:
constructing a pouch cell assembly comprising an alternating sequence of a plurality of pouch cells and a plurality of frames, wherein one frame of the plurality of frames is located adjacent a first cover portion of one of the plurality of pouch cells and another frame of the plurality of frames is located adjacent a second cover portion of the one of the plurality of pouch cells;
positioning a first contact edge of each of the plurality of pouch cells proximal to a first heat sink and a second contact edge of each of the plurality of pouch cells proximal to a second heat sink opposite the first contact edge; and
connecting the first heat sink to the first contact edge of each of the plurality of pouch cells and connecting the second heat sink to the second contact edge of each of the plurality of pouch cells.

16. The method of claim 15, wherein the connecting further comprises compressing the pouch cell assembly through uniform contact that is perpendicular to a surface area formed by the top of the pouch cell assembly, the uniform contact thereby extending a curvilinear section of the first contact edge on each of the plurality of pouch cells and extending and a curvilinear section of the second contact edge on each of the plurality of pouch cells.

17. The method of claim 16, wherein the connecting further comprises adhering the first contact edge of the plurality of pouch cells between the first heat sink and a first set of buffers, and compressing the second contact edge of the plurality of pouch cells between to the second heat sink and a second set of buffers.

18. The method of claim 15, wherein the connecting further comprises bending the first contact edge and second contact edge of each of the plurality of pouch cells to a position perpendicular to a surface area formed by the top of the pouch cell assembly, the bending occurring automatically by a set cutouts in each of the plurality of frames, wherein the set of cutouts is located to receive the first contact edge and second contact edge within the plurality of pouch cells.

19. The method of claim 15, wherein the connecting further comprises encircling a restraint around a perimeter formed of the first heat sink and the second heat sink with the pouch assembly located between the first heat sink and the second heat sink.

20. The method of claim 15, wherein the connecting further comprises contouring a contact surface on the first heat sink, such that the distance to connect the first contact edge of the plurality of pouch cells and the first heat sink is decreased, and contouring a contact surface on the second heat sink such that the distance to connect the second contact edge of the plurality of pouch cells and the second heat sink is decreased.
